(19) United States
(12) Patent Application Publication
(10) Pub. No.: US 2023/0244984 A1
(43) Pub. Date: Aug. 3, 2023

(54) AUTOMATICALLY DETERMINING USER INTENT BY SEQUENCE CLASSIFICATION BASED ON NON-TIME-SERIES-BASED MACHINE LEARNING

(71) Applicant: Walmart Apollo, LLC, Bentonville, AR (US)

(72) Inventors: Neeraj Agrawal, Agra (IN); Anshika Singh, Ghaziabad (IN); Priyanka Bhatt, Faridabad (IN)

(73) Assignee: Walmart Apollo, LLC, Bentonville, AR (US)

(21) Appl. No.: 17/589,552

(22) Filed: Jan. 31, 2022

(51) Int. Cl. G06N 20/00; G06K 9/62

(52) U.S. Cl. CPC G06N 20/00; G06K 9/6282

(57) ABSTRACT

A method implemented via execution of computing instructions configured to run at one or more processors and stored at one or more non-transitory computer-readable media. The method can include receiving, via a computer network, an intent prediction request from a frontend system. The method further can include obtaining, from a database, one or more events in a lookback period associated with one or more items ordered by a user for the intent prediction request. The method also can include determining a time-based feature encoding for the one or more events for the user by: (a) determining a feature encoding for the one or more events; (b) determining a positional encoding for the one or more events; and (c) determining the time-based feature encoding based at least in part on the feature encoding, the positional encoding, and a decay function. The positional encoding can include one or more positional vectors associated with a temporal sequence of the one or more events. The method further can include determining, in real-time via a machine learning model, a user intent for the user based on the time-based feature encoding. Other embodiments are described.

### TECHNICAL FIELD

This disclosure relates generally to automatically determining user intent by sequence classification based on non-time-series-based machine learning.

### BACKGROUND

Conventional intent determining techniques lack the ability to process time-related information in the historical data. Such information may be useful to predict what users have in mind when they reach out to a help center agent, in particular because recent incidents or events are generally more relevant to a user intent than older events. As such, conventional intent determining techniques cannot accurately predict user intent. However, existing time-series-based machine learning models, though being able to incorporate time-related information in the learning process, are generally slow and complicated. Therefore, systems and/or methods that can train a machine learning model with historical input data properly weighed according to their respective temporal information and determine user intent in real-time by the machine learning model, as trained, are desired.

### BRIEF DESCRIPTION OF THE DRAWINGS

To facilitate further description of the embodiments, the following drawings are provided in which:

FIG. 1 illustrates a front elevation view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for automatically determining user intent, according to an embodiment; and

FIG. 4 illustrates a flow chart for a method for automatically determining user intent, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 0.1 second, 0.5 second, one second, two seconds, five seconds, or ten seconds.

### DESCRIPTION OF EXAMPLES OF EMBODIMENTS

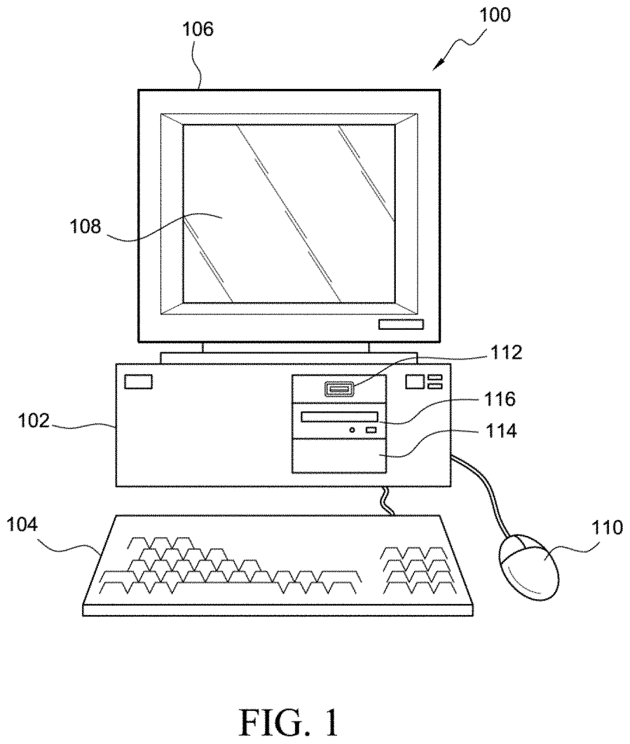

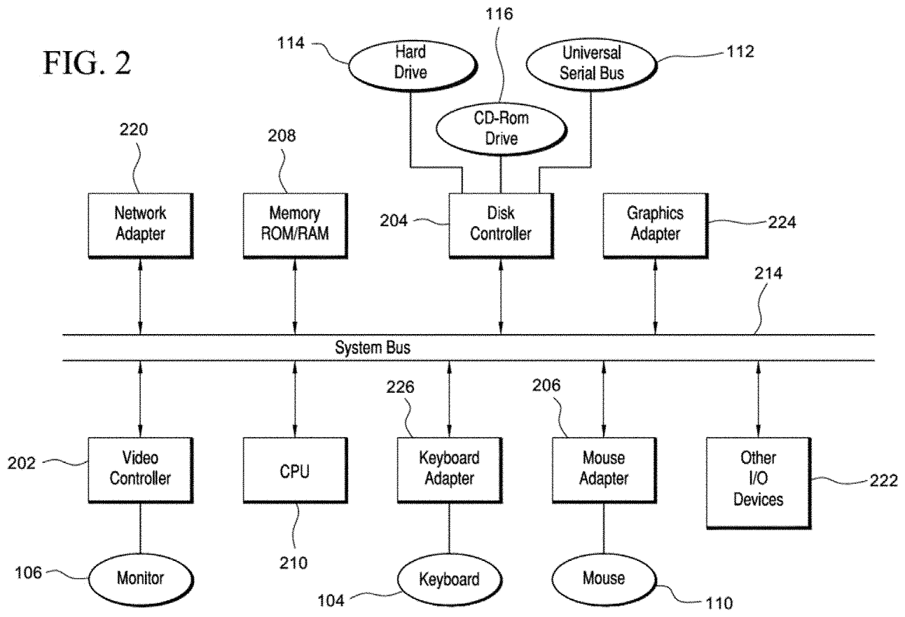

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. (Microsoft) of Redmond, Wash., United States of America, (ii) Mac® OS X by Apple Inc. (Apple) of Cupertino, Calif., United States of America, (iii) UNIX® OS, and (iv) Linux® OS. Further exemplary operating systems can comprise one of the following: (i) the iOS® operating system by Apple, (ii) the Blackberry® operating system by Research In Motion (RIM) of Waterloo, Ontario, Canada, (iii) the WebOS operating system by LG Electronics (LG) of Seoul, South Korea, (iv) the Android™ operating system developed by Google, Inc. (Google) of Mountain View, Calif., United States of America, or (v) the Windows Mobile™ operating system by Microsoft.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

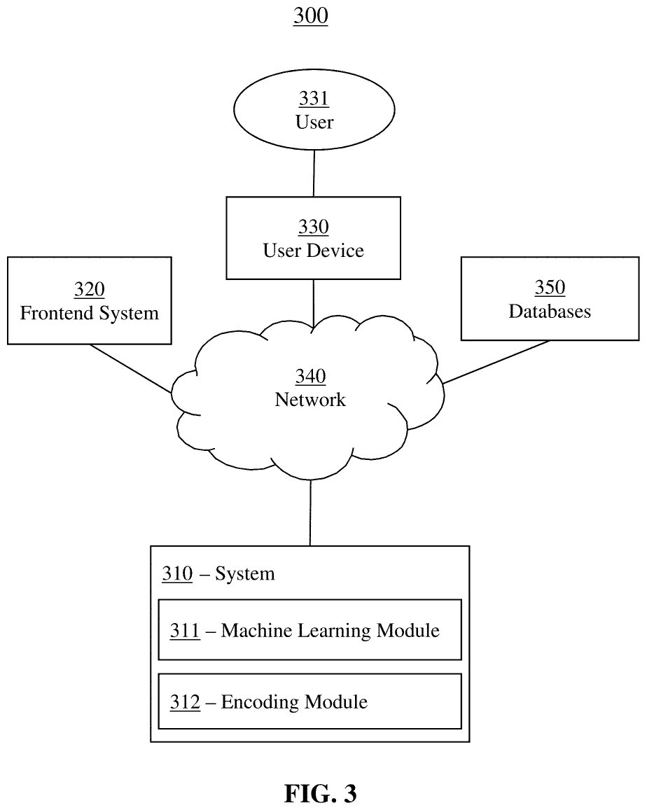

Turning ahead in the drawings, FIG. 3 illustrates a block diagram of a system 300 that can be employed for automatically determining user intent by sequence classification based on non-time-series-based machine learning, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

In some embodiments, system 300 can include one or more systems (e.g., system 310 and/or frontend system 320) and one or more user devices (e.g., user device 330) for various users (e.g., user 331). In a few embodiments, system 310 can include frontend system 320. In the same or different embodiments, system 310 can include machine learning module 311 and encoding module 312. System 310 (and each of its modules), frontend system 320, and/or user device 330 can each be a computer system, such as computer system 100 (FIG. 1), as described above, and can each be a single computer, a single server, or a cluster or collection of computers or servers, or a cloud of computers or servers. In another embodiment, a single computer system can host each of system 310 (and/or each of its modules), frontend system 320, and/or user device 330. In many embodiments, system 310 and/or each of its modules can be modules of computing instructions (e.g., software modules) stored at non-transitory computer readable media that operate on one or more processors. In other embodiments, system 310 and/or each of its modules can be implemented in hardware or combination of hardware and software. In many embodiments, system 310 and/or each of its modules can comprise one or more systems, subsystems, servers, modules, or models. Additional details regarding system 310, frontend system 320, and/or user device 330 are described herein.

In some embodiments, system 310 can be in data communication, through a network 340 (e.g., a computer network, a telephone network, and/or the Internet), with frontend system 320 and/or user device 330. In some embodiments, user device 330 can be used by users, such as user 331, respectively. In a number of embodiments, frontend system 320 can host one or more websites and/or mobile application servers. For example, frontend system 320 can host a website, or provide a server that interfaces with an application (e.g., a mobile application, a web browser, or a calendar application), on consumer devices, which allows consumers to browse or search frequently-asked-questions (FAQ), inquire about an order status, or chat with a help center agent, etc. In certain embodiments, frontend system 320 can generate an intent prediction request and transmit, via network 340 (e.g., a computer network, the telephone network, or the Internet), the intent prediction request to system 310.

In some embodiments, an internal network (e.g., network 340) that is not open to the public can be used for communications between system 310 with frontend system 320, and/or user device 330. In these or other embodiments, the operator and/or administrator of system 310 can manage system 310, the processor(s) of system 310, and/or the memory storage unit(s) of system 310 using the input device(s) and/or display device(s) of system 310.

In certain embodiments, the user devices (e.g., user device 330) can be desktop computers, laptop computers, mobile devices, and/or other endpoint devices used by one or more users (e.g., user 331). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Wash., United States of America.

In many embodiments, system 310 can include one or more input devices (e.g., one or more keyboards, one or more keypads, one or more pointing devices such as a computer mouse or computer mice, one or more touchscreen displays, a microphone, etc.), and/or can comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to system 310 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of system 310. In a similar manner, the processors and/or the non-transitory computer-readable media can be local and/or remote to each other.

Meanwhile, in many embodiments, system 310 also can be configured to communicate with one or more databases (e.g., databases 350). Databases 350 can include an event database that includes event information associated with one or more events in a lookback period (e.g., 10 days, 30 days, 60 days, 90 days, etc.) associated with one or more items ordered by a user. The event information can come from various sources, such as online chats or phone calls with a help center or agents, etc. Examples of event information in the event database can include an event type for an event (e.g., “shipped,” “orderCreated,” “returnReceived,” “returnCancelled,” “shippedLate,” etc.), an amount for an order associated with the event, a number of items for the order, a timestamp or an age of the event, and so forth.

In some embodiments, for any particular database of the one or more databases (e.g., databases 350), that particular database can be stored on a single memory storage unit or the contents of that particular database can be spread across multiple ones of the memory storage units storing the one or more databases, depending on the size of the particular database and/or the storage capacity of the memory storage units. Further, the one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, system 300, system 310, and/or the one or more databases can be implemented using any suitable manner of wired and/or wireless communication. Accordingly, system 300 and/or system 310 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 310 can receive, via network 340, an intent prediction request from a frontend system (e.g., frontend system 320). System 310 further can obtain, from a database (e.g., databases 350), one or more events in a lookback period (e.g., 30 days, 2 months, 100 days, etc.) associated with one or more items ordered by a user (e.g., user 331) for the intent prediction request.

In a number of embodiments, system 310 (and/or encoding module 312) can determine a time-based feature encoding for the one or more events for the user (e.g., user 331). System 310 (and/or encoding module 312) can determine the time-based feature encoding for the one or more events for the user by determining a feature encoding for the one or more events. The feature encoding can include one or more multi-dimensional feature vectors for the one or more events. Each of the one or more multi-dimensional feature vectors can include one or more of: an embedding for a respective event of the one or more events; an item quantity of a respective order for the respective event; an amount of the respective order; and/or a time difference between the respective event and a current time (e.g., an age of the respective event), etc. The embedding for the respective event can be created by any suitable embedding techniques (e.g., word2vec).

In some embodiments, system 310 (and/or encoding module 312) can determine the time-based feature encoding for the one or more events for the user further by determining a positional encoding for the one or more events. The positional encoding can include one or more positional vectors associated with a temporal sequence of the one or more events. In several embodiments, the positional encoding can be sinusoidal. For example, the positional encoding can include:

$$[ \begin{matrix}\begin{matrix}{v}^{( 0 )} \\ ⋮\end{matrix} \\ {v}^{( k - 1 )}\end{matrix} ] ,$$

wherein:
k is a quantity of the one or more events;
n is a length of each of one or more feature vectors of the feature encoding;
v⁽ⁱ⁾ is a positional vector of the one or more positional vectors for an i^{th} event of the one or more events, 0≤i<k;
v⁽ⁱ⁾(q), a q^{th} element of v(i), 0≤q<n, is one of:
   if (q mod 2)=0, then cos(ω_{q}xᵢ), else sin(ω_{q}xᵢ); or
   if (q mod 2)=1, then cos(ω_{q}xⱼ), else sin(ω_{q}xⱼ);
ωⱼ is a frequency for a j^{th} element of each positional vector of the one or more positional vectors, 0≤j<n; and
xⱼ is a position of the j^{th} element of each positional vector of the one or more positional vectors.

In a number of embodiments, system 310 (and/or encoding module 312) can determine the time-based feature encoding for the one or more events for the user further by: determining the time-based feature encoding based at least in part on the feature encoding, the positional encoding, and/or a decay function. In some embodiments, the decay function can be configured to determine a respective weightage for each event of the one or more events in the time-based feature encoding. For example, the respective weightage for a first event of the one or more events, as determined by the decay function, can be greater than the respective weightage for a second event of the one or more events, as determined by the decay function, when the first event is closer in time to a current time than the second event. In certain embodiments, the decay function can be linear (as above), exponential, or any of suitable decaying speed, etc., depending on the domain (e.g., retail, wholesale, etc.), as long as the more recent events are giving greater weights. In some embodiments, the decay function can include:

$$λ \frac{T - Δ {t}_{i}}{T} ,$$

wherein:
λ is a domain-specific constant, 0<λ≤1;
T is a time period of the lookback period; and
Δtᵢ is a respective time difference between an i^{th} event of the one or more events and the current time.

In certain embodiments, the time-based feature encoding used by system 310 (and/or encoding module 312) can include one or more time-based feature vectors for the one or more events. For instance, each of the one or more time-based feature vectors can be determined based on:

(v_{feature}⁽ⁱ⁾+vₚₒₛᵢₜᵢₒₙ⁽ⁱ⁾)*f_{d}(i), wherein:
v_{feature}⁽ⁱ⁾ is a feature vector of one or more feature vectors of the feature encoding for an i^{th} event of the one or more events;
vₚₒₛᵢₜᵢₒₙ⁽ⁱ⁾ is a positional vector of the one or more positional vectors of the positional encoding for the i^{th} event;
f_{d}(i) is the decay function for the i^{th} event; and
0≤i<a quantity of the one or more events.

In many embodiments, system 310 can determine, in real-time via a machine learning model (e.g., machine learning module 311), a user intent for the user (e.g., user 331) based on the time-based feature encoding. The machine learning model can be pre-trained, by system 310 or other suitable systems, based on historical time-based feature encodings for historical events for one or more users (including the user, e.g., user 331) and historical output intent data. The historical time-based feature encodings for historical events can be determined by system 310, encoding module 312, or other suitable modules. Examples of the historical output intent data can include the historical user intents identified by agents or other systems/models, etc. In many embodiments, the machine learning model for determining the user intent can include any suitable algorithms, such as a classification algorithm (e.g., random forest, XGBoost, etc.).

In a number of embodiments, system 310 can train the machine learning model (e.g., machine learning module 311) by estimating internal parameters and/or using labeled training data, otherwise known as a training dataset. In some embodiments, the training dataset for the machine learning model can be associated with all or a part of historical transaction data, historical interaction data, historical incident data, and/or historical chat data. For examples, system 310 can include a training data lookback period (e.g., 6 months, 1 year, 18 months, 3 years, etc.) for the historical transaction data, the historical interaction data, the historical incident data, and/or the historical chat data for training the machine learning model. For instance, the historical transaction data used in the training dataset for training the machine learning model (e.g., machine learning module 311) can be limited to data about historical transactions associated with users in a geographic area (e.g., a country, a continent, etc.).

In various embodiments, the machine learning model (e.g., machine learning module 311) can be pre-trained, and/or re-trained, based on a training dataset. In some embodiments, the machine learning model can also consider both historical and dynamic input from system 310. In this way, the machine learning model can be trained iteratively as data from system 310 is added to the training dataset. In many embodiments, the machine learning model can be iteratively trained in real-time as data is added to the training dataset.

Conventional time-series-based machine learning models are typically based on complicated neural networks or deep learning solutions (e.g., Long Short-Term Memory (LSTM) Networks, etc.). They generally are slow and cannot determine user intents in real-time. In many embodiments, intent determining techniques provided by system 300 and/or system 310 (and/or each of its modules) are advantageous because, even with the preparation of input data for a non-time-series-based machine learning model as described herein, determining user intents by the non-time-series-based machine learning model still would take less time than existing time-series-based machine learning models.

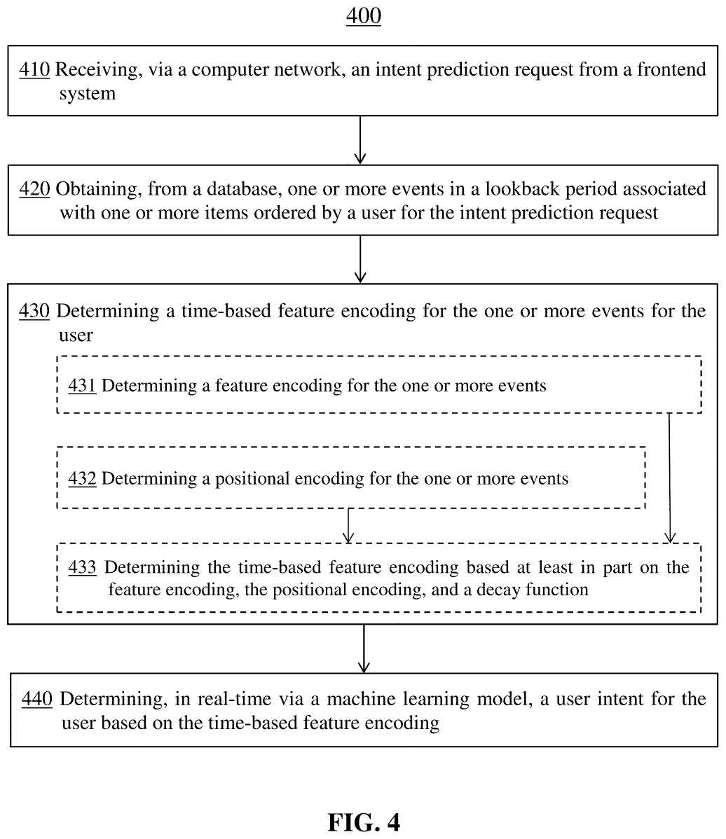

Turning ahead in the drawings, FIG. 4 illustrates a flow chart for a method 400, according to an embodiment. In many embodiments, method 400 can be implemented via execution of computing instructions on one or more processors for automatically determining user intent by sequence classification based on non-time-series-based machine learning. Method 400 is merely exemplary and is not limited to the embodiments presented herein. Method 400 can be employed in many different embodiments or examples not specifically depicted or described herein. In some embodiments, the procedures, the processes, the activities, and/or the blocks of method 400 can be performed in the order presented. In other embodiments, the procedures, the processes, the activities, and/or the blocks of method 400 can be performed in any suitable order. In still other embodiments, one or more of the procedures, the processes, the activities, and/or the blocks of method 400 can be combined or skipped.

In many embodiments, system 300 (FIG. 3) and/or system 310 (FIG. 3) (and/or one or more, or each, of its modules) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) and/or system 310 (FIG. 3). The processor(s) can be similar or identical to the processor(s) described above with respect to computer system 100 (FIG. 1).

In many embodiments, method 400 can be performed by a computer server, such as system 300 (FIG. 3) and/or system 310 (FIG. 3) (and/or each of its modules), receiving, via a computer network (e.g., network 340 (FIG. 3)), an intent prediction request from a frontend system (e.g., frontend system 320 (FIG. 3)) (block 410).

In some embodiments, method 400 further can include obtaining, from a database (e.g., databases 350 (FIG. 3)), one or more events in a lookback period (e.g., 1 month, 2 months, 3 months, etc.) associated with one or more items ordered by a user (e.g., user 331 (FIG. 3)) for the intent prediction request (block 420).

In a number of embodiments, method 400 additionally can include determining a time-based feature encoding for the one or more events for the user (block 430). In several embodiments, determining the time-based feature encoding for the one or more events in block 430 can include determining a feature encoding for the one or more events (block 431). In some embodiments, determining the time-based feature encoding for the one or more events in block 430 further can include determining a positional encoding for the one or more events (block 432). In certain embodiments, determining the time-based feature encoding for the one or more events in block 430 additionally can include determining the time-based feature encoding based at least in part on the feature encoding, the positional encoding, and/or a decay function (block 433).

In many embodiments, method 400 further can include determining, in real-time via a machine learning model, a user intent for the user based on the time-based feature encoding (block 440).

Further, in some embodiments, the feature encoding in block 431 can include one or more multi-dimensional feature vectors for the one or more events. Each of the one or more multi-dimensional feature vectors can include: an embedding for a respective event of the one or more events, an item quantity of a respective order for the respective event, an amount of the respective order, and/or a time difference between the respective event and a current time, and so forth.

In a number of embodiments, the positional encoding in block 432 can be sinusoidal. In some embodiments, the decay function can be configured to determine a respective weightage for each event of the one or more events in the time-based feature encoding, and the respective weightage for a first event of the one or more events, as determined by the decay function, can be greater than the respective weightage for a second event of the one or more events, as determined by the decay function, when the first event is closer in time to a current time than the second event.

In several embodiments, the time-based feature encoding in block 430 can include one or more time-based feature vectors for the one or more events determined based at least in part on one or more feature vectors of the feature encoding and one or more one or more positional vectors of the positional encoding.

In some embodiments, the machine learning model used in block 440 can be pre-trained based on historical time-based feature encodings for historical events for one or more users and historical output intent data. The one or more users can include the user. In certain embodiments, the machine learning model can include a classification algorithm.

Various embodiments can include a system for automatically determining user intent by sequence classification based on non-time-series-based machine learning. The system can include one or more processors and one or more non-transitory computer-readable media storing computing instructions that, when executed on the one or more processors, cause the one or more processors to perform various acts.

In a number of embodiments, the acts can include receiving, via a computer network, an intent prediction request from a frontend system. The acts further can include obtaining, from a database, one or more events in a lookback period associated with one or more items ordered by a user for the intent prediction request. In some embodiments, the acts also can include determining a time-based feature encoding for the one or more events for the user by: (a) determining a feature encoding for the one or more events; (b) determining a positional encoding for the one or more events; and (c) determining the time-based feature encoding based at least in part on the feature encoding, the positional encoding, and a decay function. The positional encoding can include one or more positional vectors associated with a temporal sequence of the one or more events. In some embodiments, the acts further can include determining, in real-time via a machine learning model, a user intent for the user based on the time-based feature encoding.

Further, various embodiments can include a method being implemented via execution of computing instructions configured to run at one or more processors and stored at one or more non-transitory computer-readable media. The method can include receiving, via a computer network, an intent prediction request from a frontend system. The method further can include obtaining, from a database, one or more events in a lookback period associated with one or more items ordered by a user for the intent prediction request. The method also can include determining a time-based feature encoding for the one or more events for the user by: (a) determining a feature encoding for the one or more events; (b) determining a positional encoding for the one or more events; and (c) determining the time-based feature encoding based at least in part on the feature encoding, the positional encoding, and a decay function. The positional encoding can include one or more positional vectors associated with a temporal sequence of the one or more events. The method further can include determining, in real-time via a machine learning model, a user intent for the user based on the time-based feature encoding.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although automatically determining user intent by sequence classification based on non-time-series-based machine learning has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-4 may be modified, and that the foregoing discussion of certain of these embodiments does not necessarily represent a complete description of all possible embodiments. Different decay functions, feature/positional/time-based feature encoding techniques, and/or machine learning algorithms may be used. Various training datasets also can be used for training the machine learning model described herein.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, cause the one or more processors to perform:
receiving, via a computer network, an intent prediction request from a frontend system;
obtaining, from a database, one or more events in a lookback period associated with one or more items ordered by a user for the intent prediction request;
determining a time-based feature encoding for the one or more events for the user by:
determining a feature encoding for the one or more events;
determining a positional encoding for the one or more events, wherein:
the positional encoding comprises one or more positional vectors associated with a temporal sequence of the one or more events; and
determining the time-based feature encoding based at least in part on the feature encoding, the positional encoding, and a decay function; and
determining, in real-time via a machine learning model, a user intent for the user based on the time-based feature encoding.

2. The system in claim 1, wherein:
the feature encoding comprises one or more multi-dimensional feature vectors for the one or more events.

3. The system in claim 2, wherein:
each of the one or more multi-dimensional feature vectors comprises one or more of:
an embedding for a respective event of the one or more events;
an item quantity of a respective order for the respective event;
an amount of the respective order; or
a time difference between the respective event and a current time.

4. The system in claim 1, wherein:
the positional encoding is sinusoidal.

5. The system in claim 4, wherein:
the positional encoding comprises:
$$[ \begin{matrix}\begin{matrix}{v}^{( 0 )} \\ ⋮\end{matrix} \\ {v}^{( k - 1 )}\end{matrix} ] ,$$
wherein:
k is a quantity of the one or more events;
n is a length of each of one or more feature vectors of the feature encoding;
v⁽ⁱ⁾ is a positional vector of the one or more positional vectors for an i^{th} event of the one or more events, 0≤i<k;
v⁽ⁱ⁾(q), a q^{th} element of v⁽ⁱ⁾, 0≤q<n, is one of:
if (q mod 2)=0, then cos(ω_{q}xᵢ), else sin(ω_{q}xᵢ); or
if (q mod 2)=1, then cos(ω_{q}xⱼ), else sin(ω_{q}xⱼ);
ωⱼ is a frequency for a j^{th} element of each positional vector of the one or more positional vectors, 0≤j<n; and
xⱼ is a position of the j^{th} element of each positional vector of the one or more positional vectors.

6. The system in claim 1, wherein:
the decay function is configured to determine a respective weightage for each event of the one or more events in the time-based feature encoding; and
the respective weightage for a first event of the one or more events, as determined by the decay function, is greater than the respective weightage for a second event of the one or more events, as determined by the decay function, when the first event is closer in time to a current time than the second event.

7. The system in claim 6, wherein:
the decay function comprises:
$$λ \frac{T - Δ {t}_{i}}{T} ,$$
wherein:
λ is a domain-specific constant, 0<λ≤1;
T is a time period of the lookback period; and
Δtᵢ is a respective time difference between an i^{th} event of the one or more events and the current time.

8. The system in claim 1, wherein:
the time-based feature encoding comprises one or more time-based feature vectors for the one or more events; and
each of the one or more time-based feature vectors is determined based on:
(v_{feature}⁽ⁱ⁾+vₚₒₛᵢₜᵢₒₙ⁽ⁱ⁾)*f_{d}(i), wherein:
v_{feature}⁽ⁱ⁾ is a feature vector of one or more feature vectors of the feature encoding for an i^{th} event of the one or more events;
vₚₒₛᵢₜᵢₒₙ⁽ⁱ⁾ is a positional vector of the one or more positional vectors of the positional encoding for the i^{th} event;
f_{d}(i) is the decay function for the i^{th} event; and
0≤i<a quantity of the one or more events.

9. The system in claim 1, wherein:
the machine learning model is pre-trained based on historical time-based feature encodings for historical events for one or more users and historical output intent data; and
the one or more users comprise the user.

10. The system in claim 1, wherein:
the machine learning model comprises a classification algorithm.

11. A method being implemented via execution of computing instructions configured to run at one or more processors and stored at one or more non-transitory computer-readable media, the method comprising:
receiving, via a computer network, an intent prediction request from a frontend system;
obtaining, from a database, one or more events in a lookback period associated with one or more items ordered by a user for the intent prediction request;
determining a time-based feature encoding for the one or more events for the user by:
determining a feature encoding for the one or more events;
determining a positional encoding for the one or more events, wherein:
the positional encoding comprises one or more positional vectors associated with a temporal sequence of the one or more events; and
determining the time-based feature encoding based at least in part on the feature encoding, the positional encoding, and a decay function; and
determining, in real-time via a machine learning model, a user intent for the user based on the time-based feature encoding.

12. The method in claim 11, wherein:
the feature encoding comprises one or more multi-dimensional feature vectors for the one or more events.

13. The method in claim 12, wherein:
each of the one or more multi-dimensional feature vectors comprises one or more of:
an embedding for a respective event of the one or more events;
an item quantity of a respective order for the respective event;
an amount of the respective order; or
a time difference between the respective event and a current time.

14. The method in claim 11, wherein:
the positional encoding is sinusoidal.

15. The method in claim 14, wherein:
the positional encoding comprises:
$$[ \begin{matrix}\begin{matrix}{v}^{( 0 )} \\ ⋮\end{matrix} \\ {v}^{( k - 1 )}\end{matrix} ] ,$$
wherein:
k is a quantity of the one or more events;
n is a length of each of one or more feature vectors of the feature encoding;
v⁽ⁱ⁾ is a positional vector of the one or more positional vectors for an i^{th} event of the one or more events, 0≤i<k;
v⁽ⁱ⁾(q), a q^{th} element of v⁽ⁱ⁾, 0≤q<n, is one of:
if (q mod 2)=0, then cos(ω_{q}xᵢ), else sin(ω_{q}xᵢ); or
if (q mod 2)=1, then cos(ω_{q}xⱼ), else sin(ω_{q}xⱼ);
ωⱼ is a frequency for a j^{th} element of each positional vector of the one or more positional vectors, 0≤j<n; and
xⱼ is a position of the j^{th} element of each positional vector of the one or more positional vectors.

16. The method in claim 11, wherein:
the decay function is configured to determine a respective weightage for each event of the one or more events in the time-based feature encoding; and
the respective weightage for a first event of the one or more events, as determined by the decay function, is greater than the respective weightage for a second event of the one or more events, as determined by the decay function, when the first event is closer in time to a current time than the second event.

17. The method in claim 16, wherein:
the decay function comprises:
$$λ \frac{T - Δ {t}_{i}}{T} ,$$
wherein:
λ is a domain-specific constant, 0<λ≤1;
T is a time period of the lookback period; and
Δtᵢ is a respective time difference between an i^{th} event of the one or more events and the current time.

18. The method in claim 11, wherein:
the time-based feature encoding comprises one or more time-based feature vectors for the one or more events; and
each of the one or more time-based feature vectors is determined based on:
(v_{feature}⁽ⁱ⁾+vₚₒₛᵢₜᵢₒₙ⁽ⁱ⁾)*f_{d}(i), wherein:
v_{feature}⁽ⁱ⁾ is a feature vector of one or more feature vectors of the feature encoding for an i^{th} event of the one or more events;
vₚₒₛᵢₜᵢₒₙ⁽ⁱ⁾ is a positional vector of the one or more positional vectors of the positional encoding for the i^{th} event;
f_{d}(i) is the decay function for the i^{th} event; and
0≤i<a quantity of the one or more events.

19. The method in claim 11, wherein:
the machine learning model is pre-trained based on historical time-based feature encodings for historical events for one or more users and historical output intent data; and
the one or more users comprise the user.

20. The method in claim 11, wherein:
the machine learning model comprises a classification algorithm.
